(19) United States
(12) Patent Application Publication
(10) Pub. No.: US 2004/0026868 A1
(43) Pub. Date: Feb. 12, 2004

(54) Face seal with secondary seal

(76) Inventor: John C. Dahlheimer, Laconia, NH (US)

Correspondence Address: FREUDENBERG-NOK GENERAL PARTNERSHIP, INTELLECTUAL PROPERTY DEPT., 47690 EAST ANCHOR COURT, PLYMOUTH, MI, 48170-2455, US

(21) Appl. No.: 10/634,040

(22) Filed: Aug. 1, 2003

Related U.S. Application Data
(60) Provisional application No. 60/400,622, filed on Aug. 2, 2002.

(51) Int. Cl. F16J 15/34

(52) U.S. Cl. 277/352

(57) ABSTRACT

A face seal assembly is disclosed that includes a seal case having an end wall portion and a seal case neck extending from the end wall portion. A seal ring is rotationally fixed relative to the seal case and has a seal ring bore recessed therein that faces the seal case neck. A seal seat mounts against the sealing surface of the seal ring and is rotatable relative to the seal ring, while a primary spring is mounted between the end wall portion and the seal ring for biasing the seal ring sealing surface against the seal seat. A secondary seal having a PTFE portion and a secondary seal spring located within the PTFE portion is located between the seal ring bore and the seal case neck such that a radial sealing pre-load is created between the seal ring bore and the seal case neck.

### BACKGROUND OF INVENTION

The present invention relates to face seal assemblies and particularly to face seal assemblies that include secondary seals.

Many conventional face seal assemblies employ a secondary seal in order to assure a complete seal. For applications where the fluid being sealed prevents rubber or other conventional type of sealing material from being used for the secondary seal, polytetrafluoroethylene (PTFE) may be employed. Moreover, for some of the applications which require a PTFE seal, the seal may see relatively high pressures and require a very high standard against leakage. For these applications, premature seal wear and the potential for leakage is undesirable.

A typical arrangement for PTFE face seal assemblies is a conventional face seal with a PTFE pusher-type secondary seal. Such face seal assemblies mount a seal ring and the secondary seal to a shaft (or sleeve), which rotate with the shaft, while mounting a seal seat to a stationary housing. An axial compression spring is then used to simultaneously pre-load the PTFE secondary seal between the seal ring and the shaft and pre-load the seal ring against the seal seat.

One type of these face seal assemblies with the PTFE pusher type seals employs a secondary PTFE U-cup, V-cup or C-cup seal to seal between the shaft and the seal ring. Typically, the radially outer and inner lips of the PTFE cup are wedged outward against the seal ring (or a seal washer) and inward against the shaft by a metal base ring. The base ring is provided with ramped surfaces that, with the axial spring load, engage and spread the outer and inner lips of the secondary seal. This same axial spring load also axially pre-loads the seal ring against the seal seat. A disadvantage with this secondary seal is that the distribution of pre-loading is not even. That is, due to tolerances of the various components, the base ring either contacts the outer lip or the inner lip first, which means that one lip will have higher than optimum force and the other lip will have less than the optimum force. Another disadvantage is that there is limited conformability for the secondary seal to account for an out-of-round seal ring bore and/or shaft since the rigid metal base ring resists bending out-of-round.

Another type of these face seal assemblies with the PTFE pusher type seals employs a PTFE wedge ring as a secondary seal in order to seal between the seal ring and the shaft. Typically an axial compression spring or a set of springs act against a plain metal washer that in turn biases the PTFE wedge ring into a conically shaped bore provided in the back of the seal ring. This spring bias presses a blunted, narrow edge of the wedge ring against the conical bore. In doing so, the narrow edge is deflected tighter against the shaft. The same axial spring force applied to the metal washer also pre-loads the seal ring axially against the seal seat. A disadvantage with this secondary seal is that the distribution of pre-load forces is not even. That is, the amount of stretch the wedge ring has around the shaft will either create a higher than optimum lip force on the shaft and a less than optimum force against the conical bore, or, conversely, a lower than optimum lip force on the shaft and a higher than optimum force acting against the conical bore. Another disadvantage is that, once the wedge ring is stretched out around the shaft it can no longer easily conform to an out-of-round conical bore.

Due to the disadvantages inherent in both of the PTFE pusher type secondary seals discussed above—that is, the pre-load variation and poor conformability to out-of-round parts—these secondary seals require higher axial spring forces than is desired in order to assure a good seal. This higher axial spring force results in higher wear of the PTFE secondary seals and the surfaces against which they rub, such as the shafts. Worn shafts, in turn, can abrade the seals, thus creating leak paths. Moreover, since these PTFE pusher type secondary seals mount the secondary seal and the seal ring on the shaft (for rotation with the shaft), while mounting the seal seat on a stationary housing, if the shaft is not perfectly aligned with the housing, then the seal ring and PTFE secondary seal will wobbled back and forth on the shaft with each rotation. This can lead to premature wear of the seal, thus reducing the life of the face seal assembly.

Consequently, it is desired to have a face seal assembly that is satisfactory for providing a good seal with limited wear that will provide for a long seal life. This is particularly true for applications where a seal requires a very high standard against leakage and the material being sealed prevents rubber or other similar materials from being employed for the seals.

### SUMMARY OF INVENTION

In its embodiments, the present invention contemplates a face seal assembly, with the face seal assembly including a seal case having an end wall portion extending in a generally radial direction, and a seal case neck extending from the end wall portion in a generally axial direction. A seal ring is rotationally fixed relative to the seal case, located radially outward of the seal case neck, has a radially inward facing surface with a seal ring bore recessed therein, and has a sealing surface. A seal seat is mounted against the sealing surface of the seal ring and rotatable relative to the seal ring, while a primary spring is mounted between the end wall portion and the seal ring for biasing the seal ring sealing surface against the seal seat. The face seal assembly also includes a secondary seal having a PTFE portion and a secondary seal spring located within the PTFE portion, with the secondary seal being located between the seal ring bore and the seal case neck with an interference fit whereby a radial sealing pre-load is created between the seal ring bore and the seal case neck.

An advantage of an embodiment of the present invention is that the essentially independent inner and outer lips of the secondary seal being acted upon by the secondary seal spring allows for equalized forces acting on both lips. Another advantage of an embodiment of the present invention is that the secondary seal allows for the inner and outer lips of the seal to independently flex to conform to out-of-round conditions of the mating surfaces. These two advantages allow for the secondary seal to seal adequately with lower radial spring force pre-loads than prior face seal assembly designs.

A further advantage of an embodiment of the present invention is that the secondary seal, which can seal adequately with lower radial spring force pre-loads, allows for lower wear rates, thus increasing the life of the seal.

An additional advantage of an embodiment of the present invention is that any shaft to seal case misalignment can be accommodated by a tilting of the seal ring and secondary seal, rather than prior face seals where any misalignment would cause the seal ring to wobble back and forth with each rotation. Consequently, both the seal ring and secondary seal have reduced wear, which increases the life of the face seal assembly.

A further advantage that can be attained with an embodiment of the present invention is that a controlled smoothness of the seal case neck can promote a thin film of PTFE to transfer from the secondary seal to the surface of the seal case neck without causing excessive wear of the secondary seal. Such a thin film will provide for a PTFE to PTFE sliding contact, which can significantly reduce the rate of wear for the secondary seal. Moreover, if the seal case neck is formed of a hardened stainless steel, this will act to further improve wear resistance.

This face seal assembly, due to its good sealing and low wear properties, is particularly advantageous where long seal life requirements and very high standards against leakage preclude the use of the conventional types of face seal assemblies having PTFE secondary seals.

### BRIEF DESCRIPTION OF DRAWINGS

FIG. 1 is a perspective view of a face seal assembly according to a preferred embodiment of the invention.

FIG. 2 is a cross sectional view taken along line 2-2 of FIG. 1.

FIG. 3 is a cross sectional view, on an enlarged scale and rotated 135 degrees clockwise, taken along line 3-3 of FIG. 2.

FIG. 4 is a cross sectional view, on an enlarged scale and rotated 90 degrees clockwise, taken along line 4-4 of FIG. 2.

FIG. 5 is perspective view similar to FIG. 1, but illustrating a second embodiment of the present invention.

FIG. 6 is a cross sectional view taken along line 6-6 of FIG. 5.

FIG. 7 is a cross sectional view, on an enlarged scale and rotated 135 degrees clockwise, taken along line 7-7 in FIG. 6.

FIG. 8 is a cross sectional view, on an enlarged scale and rotated 90 degrees clockwise, taken along line 8-8 in FIG. 6.

FIG. 9 is a cross sectional view of a face seal assembly, illustrating a third embodiment of the present invention.

### DETAILED DESCRIPTION

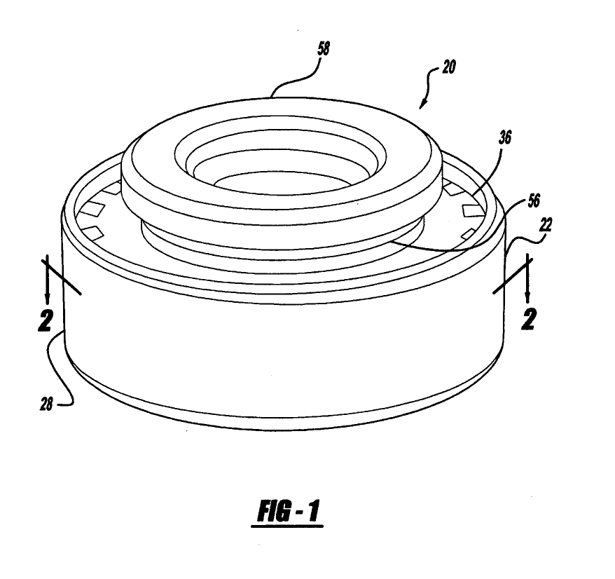

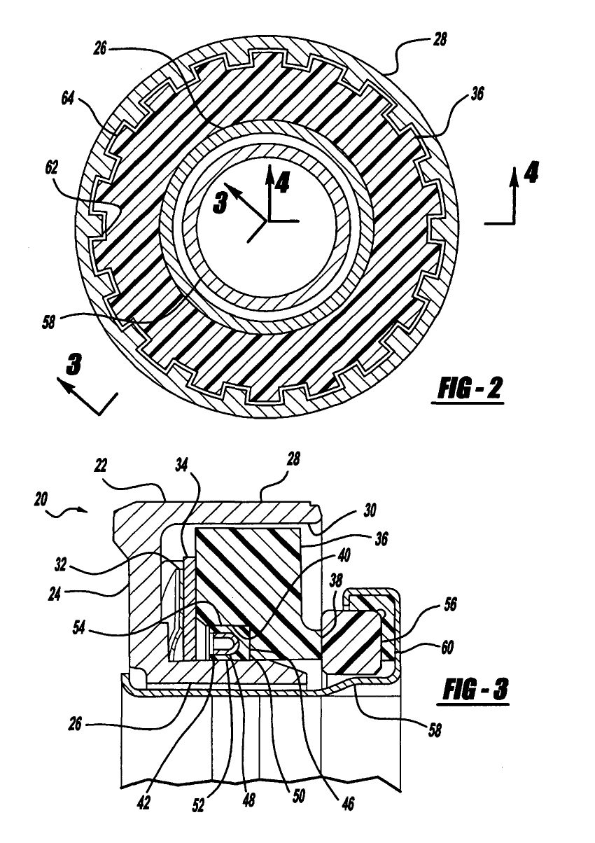

FIGS. 1-4 illustrate a face seal assembly 20 that includes a seal case 22, which is preferably mounted in a stationary fashion to a housing (not shown). The seal case 22 includes an end wall portion 24, which is generally circular in shape. A generally cylindrical seal case neck 26 extends from a radially inner end of the end wall portion 24, and a generally cylindrical outer seal case wall 28 extends from a radially outer end of the end wall portion 24 to form a cavity 30 in the seal case 22. The seal case is preferably formed of stainless steel, although other suitable materials may also be employed.

A primary spring 32 mounts against the end wall portion 24 within the cavity 30, and extends around the seal case neck 26. The primary spring 32 is preferably a wave spring that is made of beryllium copper, although other suitable springs and materials may also be employed. A flat, circular seal washer 34 is mounted against the primary spring 32 in the cavity 30 so that the primary spring 32 is sandwiched between the end wall portion 24 and the seal washer 34. The seal washer is preferably made of stainless steel, although other suitable materials may also be employed.

A seal ring 36 mounts within the cavity 30, and extends around the seal case neck 26. The seal ring 36 is in contact with the seal washer 34 on a first side, and has a sealing surface 38 extending from an opposite side. A seal ring bore 40 is recessed within the seal ring 36 on its radially inner surface. The seal ring 36 is preferably made of carbon graphite, although other suitable materials for a face seal material may also be employed. The radially outer surface of the seal ring 36 includes a number of spaced seal ring teeth 64. These teeth mate with a series of seal case teeth 62 that are formed on the radially inner surface of the outer seal case wall 28. This arrangement of teeth 62, 64 rotationally fixes the seal ring 36 to the seal case 22 while allowing the two to slide axially relative to one another.

A secondary seal 42 is mounted in the seal ring bore 40 about a sealing surface 44 on the radially outer side of the seal case neck 26. The secondary seal 42 includes a polytetrafluoroethylene (PTFE) portion 46 that surrounds a secondary seal spring 48. The PTFE portion 46 includes a base portion 50, with a radially inner lip 52 and a radially outer lip 54 extending therefrom. The PTFE material used for the secondary seal 42 may be in virgin form, or preferably, is reinforced with polyimids, graphite, coke, molybdenum-disulfide, bronze, or combinations thereof, in order to enhance the wear resistance. The secondary seal spring 48 is preferably encapsulated in the PTFE portion 46. It is preferably made of stainless steel, although other suitable materials may also be employed. The secondary seal spring 48 is illustrated as a ribbon U-cup shaped cross section. However, this spring 48 can also be a ribbon C-cup or V-cup cross section, as well as various types of ribbon or wire helical coil springs.

The secondary seal 42 is installed between the seal ring bore 40 and the seal case neck 26 with an interference fit so that the secondary seal spring 48 is compressed in the radial direction during assembly. This will cause the secondary seal spring 48 to exert a radial sealing force that presses the radially inner lip 52 against the seal case neck 26, and the radially outer lip 54 against the seal ring bore 40.

The open end of the secondary seal 42, that is, the end opposite the PTFE base portion 50, is preferably oriented such that it faces the high pressure fluid side. The high pressure fluid, then, will act in conjunction with the secondary seal spring 48 to create a greater sealing force for the seal lips 52 and 54 acting against the seal case neck 26 and the seal ring bore 40, respectively. Also, since the inner lip 52 and outer lip 54 are essentially independent, this will allow for essentially equalized pre-load forces on each lip 52, 54. With the applied sealing forces, then, the secondary seal 42 will prevent leakage between the seal ring 36 and the seal case neck 26 even though the two are axially slidable relative to one another.

The actual desired amount of pre-load created by this installation will vary based upon the particular application for the face seal assembly 20, the type of cup configuration employed, the pressure of the fluid being sealed, and the PTFE filler used, if any, but is preferably just sufficient to provide initial conformance to out-of round conditions in order to have complete sealing. This will allow for good sealing without causing excessive wear of the secondary seal 42 under seal operating conditions.

As discussed above, the seal case 22 is preferably made of stainless steel. The seal case material is preferably hardened to a 40 Rockwell “C” minimum, although this may vary depending upon the particular application, among other factors. The case neck sealing surface 44 is preferably provided with a surface finish ranging from about 4 to 8, 6 to 12, or 8 to 16 micro-inch Ra, depending upon the particular fluid to be sealed. This sealing surface 44 of hardened material with a closely controlled fine surface finish is preferred as the sealing surface against which the radially inner lip 52 slides because this will provide for even greater extended operational life of the secondary seal 42.

The face seal assembly 20 also includes a seal seat 56 that mounts to a sleeve 58 via a grommet 60. The seal seat 56 is rotationally fixed to and rotates with the sleeve 58, while the seal ring 36 is rotationally fixed to the seal case 22, which causes the sealing surface 38 slide on the seal seat 56 during operation of the face seal assembly 20. The seal seat 56 is preferably made of silicon carbide for good wear resistance when sliding in surface contact with the seal ring 36, and the sleeve 58 is preferably made of stainless steel, although, of course, both may be formed of other suitable materials.

The seal ring 36, then, is axially pre-loaded against the seal seat 56 by the primary spring 32 (or set of springs as the case may be), which creates an axial pre-load between the seal ring 36 and the seal seat 56. This pre-load is optimized to minimize wear and prevent leakage between the seal ring 36 and the seal seat 56, but without the need to also account for the pre-load needed for the secondary seal 42 as is the case with conventional face seal assemblies. This is possible because, as discussed above, the secondary seal 42 accomplishes its sealing function without the need for any pre-load to be generated by the primary spring 32.

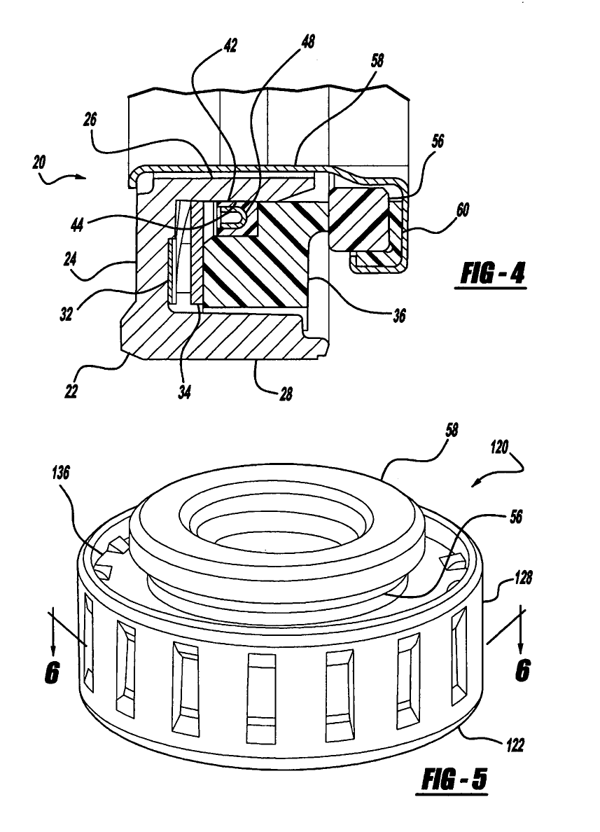

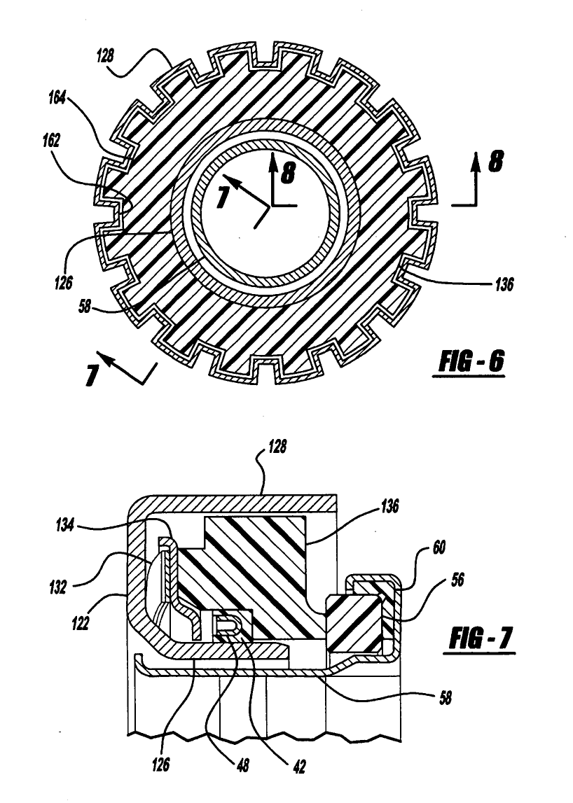

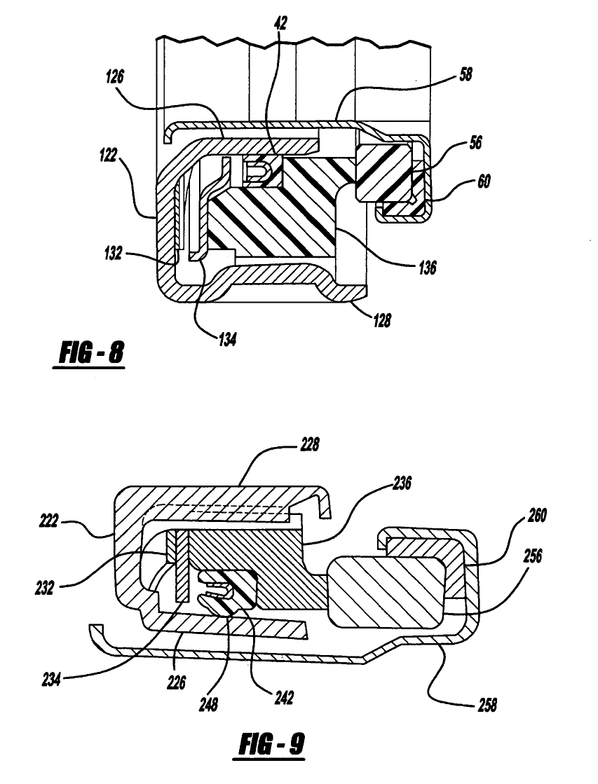

A second embodiment of the present invention is shown in FIGS. 5-8. Elements in this embodiment that are similar to elements in the first embodiment will be similarly designated, but with a 100-series number, while elements that are the same will be designated with the same number. The seal seat 56, sleeve 58, grommet 60 and secondary seal 42, with secondary seal spring 48, are the same as in the first embodiment. The seal case 122 is now preferably formed from stock with essentially a single material thickness, making it less costly to fabricate than the seal case in the first embodiment. In order to account for this, the seal case neck 126 and the outer seal case wall 128 have somewhat different shapes, but perform the same functions as in the first embodiment. The shape of the primary spring 132, washer 134 and seal ring 136 are changed to fit into the new shape of the seal case 122, but also perform the same functions as in the first embodiment. The seal ring teeth 164 are now formed by stamping portions of the material of the outer seal case wall 128 radially inward. The seal case teeth 162 are formed to mate with the seal ring teeth 164, which prevents rotation of the seal ring 136 relative to the seal case 122 while still allowing for axial motion.

A third embodiment is illustrated in FIG. 9. Elements in this embodiment that are similar to elements in the first embodiment will be similarly designated, but with 200 series numbers. This embodiment is very similar to the first two embodiments, with some changes to the shapes of the components. The sleeve 258 and grommet 260 are shaped to account for the different shape of the seal seat 256, which is axially longer than in the first two embodiments. The seal case 222 is radially narrower than in the first two embodiments, with the seal case neck 226 and the outer seal case wall 228 shaped to account for this. Since the radially inner surface of the seal ring 236 is not immediately adjacent to the seal case neck 226, the secondary seal 242 extends out from the seal ring 236 to assure contact with and sealing against the seal case neck 226. The secondary seal spring 248 is also sized to account for this. The primary spring 232 and seal washer 234 are shaped somewhat differently to account for the different shape of the seal case 222, but perform the same function as in the first two embodiments.

Of course, another alternative to the embodiments shown is that the seal seat mounts to and rotates directly with a shaft rather than the sleeve. And, as mentioned above, while the secondary seal spring is shown as a U-cup, other types and shapes of springs can be employed for the secondary seal spring instead, if so desired. Moreover, while the seal case is illustrated as separate from and mountable to a housing, it can be made integral with a housing, if so desired. Also, the seal spring, while illustrated as a wave spring, may employ a different kind of spring, so long as this spring provides the desired pre-load on the seal ring. Consequently, while the invention has been described with a preferred and alternative embodiments, it is not intended to limit the scope of the invention to the embodiments disclosed but to embrace all variations within the scope of the appended claims.

What is claimed is:

1. A face seal assembly comprising:
a seal case having an end wall portion extending in a generally radial direction, and a seal case neck extending from the end wall portion in a generally axial direction;
a seal ring rotationally fixed relative to the seal case, located radially outward of the seal case neck, having a radially inward facing surface with a seal ring bore recessed therein, and having a sealing surface;
a seal seat mounted against the sealing surface of the seal ring and rotatable relative to the seal ring;
a primary spring mounted between the end wall portion and the seal ring for biasing the seal ring sealing surface against the seal seat; and
a secondary seal having a PTFE portion and a secondary seal spring located within the PTFE portion, with the secondary seal being located between the seal ring bore and the seal case neck with an interference fit whereby a radial sealing pre-load is created between the seal ring bore and the seal case neck.

2. The face seal assembly of claim 1 wherein the seal case includes an outer seal case wall extending from the wall portion in a generally axial direction and including a plurality of seal case teeth, and the seal ring includes a plurality of seal ring teeth interleaved with the seal case teeth to thereby prevent rotation of the seal ring relative to the seal case.

3. The face seal assembly of claim 1 further including a seal washer located between the primary seal spring and the seal ring.

4. The face seal assembly of claim 1 further including a sleeve that is rotationally fixed to the seal seat.

5. The face seal assembly of claim 4 further including a grommet mounted between the sleeve and the seal seat.

6. The face seal assembly of claim 1 wherein the seal case neck is made of a material that is hardened to a 40 Rockwell “C” minimum.

7. The face seal assembly of claim 6 wherein the seal case neck is made of stainless steel.

8. The face seal assembly of claim 6 wherein the seal case neck includes a sealing surface that abuts the secondary seal, and the sealing surface has a surface finish ranging from one of 4 to 8, 6 to 12, or 8 to 16 micro-inch Ra.

9. The face seal assembly of claim 1 wherein the seal case neck includes a sealing surface that abuts the secondary seal, and the sealing surface has a surface finish ranging from one of 4 to 8, 6 to 12, or 8 to 16 micro-inch Ra.

10. The face seal assembly of claim 1 wherein the PTFE portion of the secondary seal is made of PTFE reinforced with at least one of a polyimid, graphite, coke, molybdenum-disulfide, and bronze.

11. The face seal assembly of claim 10 wherein the secondary seal spring has a U-shaped cross section and the PTFE portion includes a radially inner lip biased against the seal case neck and a radially outer sealing lip biased against the seal ring bore.

12. The face seal assembly of claim 1 wherein the secondary seal spring has a U-shaped cross section and the PTFE portion includes a radially inner sealing lip biased against the seal case neck and a radially outer sealing lip biased against the seal ring bore.

13. The face seal assembly of claim 12 wherein the face seal is adapted to seal against a high pressure, and wherein the radially inner sealing lip and the radially outer sealing lip are adapted to extend generally axially toward the high pressure.

14. The face seal assembly of claim 1 wherein the primary spring is a wave spring.

15. The face seal assembly of claim 14 wherein the primary spring is made of beryllium copper.

16. The face seal assembly of claim 1 wherein the seal spring is made of stainless steel.

17. The face seal assembly of claim 1 wherein the seal ring is made of carbon graphite.

18. A face seal assembly comprising:
a seal case having an end wall portion extending in a generally radial direction, a seal case neck extending from the end wall portion in a generally axial direction, and an outer seal case wall extending from the wall portion in a generally axial direction and including a plurality of seal case teeth;
a seal ring rotationally fixed relative to the seal case, located radially outward of the seal case neck, having a radially inward facing surface with a seal ring bore recessed therein, having a sealing surface, and including a plurality of seal ring teeth interleaved with the seal case teeth to thereby prevent rotation of the seal ring relative to the seal case;
a seal seat mounted against the sealing surface of the seal ring and rotatable relative to the seal ring;
a primary spring mounted between the end wall portion and the seal ring for biasing the seal ring sealing surface against the seal seat; and
a secondary seal located between the seal ring bore and the seal case neck with an interference fit whereby a radial sealing pre-load is created between the seal ring bore and the seal case neck.

19. A face seal assembly comprising:
a seal case having an end wall portion extending in a generally radial direction, and a seal case neck extending from the end wall portion in a generally axial direction;
a seal ring rotationally fixed relative to the seal case, located radially outward of the seal case neck, having a radially inward facing surface with a seal ring bore recessed therein, and having a sealing surface;
a seal seat mounted against the sealing surface of the seal ring and rotatable relative to the seal ring;
a primary spring mounted between the end wall portion and the seal ring for biasing the seal ring sealing surface against the seal seat;
a secondary seal having a PTFE portion and a secondary seal spring located within the PTFE portion, with the secondary seal being located between the seal ring bore and the seal case neck with an interference fit whereby a radial sealing pre-load is created between the seal ring bore and the seal case neck; and
a sleeve that is rotationally fixed to the seal seat.

20. The face seal assembly of claim 19 wherein the seal seat is made of silicon carbide.
